(19) United States
(12) Patent Application Publication
(10) Pub. No.: US 2016/0256246 A1
(43) Pub. Date: Sep. 8, 2016

(54) NEGATIVE AND POSITIVE MERGE MODELLING

(71) Applicant: Sun Dental Holding, LLC., St. Petersburg, FL (US)

(72) Inventors: Charles Stapleton, St. Petersburg, FL (US); Drew Fabiano, St. Petersburg, FL (US)

(21) Appl. No.: 14/635,123

(22) Filed: Mar. 2, 2015

(51) Int. Cl. A61C 13/00; A61C 13/34

(52) U.S. Cl. CPC A61C 13/0004; A61C 13/34; A61C 13/0006

(57) ABSTRACT

The technology relates to modelling a prepared tooth for fitting a prosthetic thereon. A die, representative of a prepared tooth, may be modelled as a positive virtual three-dimensional die model. An impression of a set of teeth surrounding and including the prepared tooth may be modelled as a negative virtual three-dimensional impression model. The negative virtual three-dimensional impression may be inverted to create a positive virtual three-dimensional impression model. The positive virtual three-dimensional impression model and the positive virtual three-dimensional die model may then be merged to create a virtual three-dimensional dentition model.

### BACKGROUND OF THE TECHNOLOGY

Dental prostheses, such as dental crowns, may be designed and modelled based on virtual models representative of a patient's dentition. In order to create a virtual model of a patient's dentition, a variety of techniques may be employed.

The standard and predominant technique for creating a model of a patient's dentition is to create an entire casted model of the patient's dentition. First, a patient may sit for a full impression of the patient's dentition to be made (the negative image of the patient's dentition). The full impression may include all of the patient's teeth, including the tooth or teeth for which a prosthetic will be fitted, the surrounding teeth, and the opposing teeth. Subsequently, an entire casted model of the patient's dentition is made. For example, plaster may be poured into the impression of the patient's dentition and allowed to harden before being removed from the impression of the patient's dentition. The hardened plaster is now a positive casted model of the patient's dentition including a die which is representative of the tooth or teeth on which a prosthetic will be fit. Upon removing the hardened positive casted model from the impression of the patient's dentition, the positive casted model needs to be trimmed, pinned, based, and sectioned by a dental technician to provide an accurate representation of the patient's dentition. After preparing the positive casted model, the remaining positive casted model may represent all of a patient's teeth. The remaining casted model may then be scanned to create a positive model of the patient's dentition within a computer program. While casted models may allow for very accurate modelling, creating an entire positive model of a patient's dentition is very time consuming process. Additionally, as only a portion of the positive model, including the die, is usually needed to prepare the prosthesis, materials may be wasted in modelling the entire dentition of the patient.

Another technique of modeling a patient's dentition is by scanning an impression of a patient's dentition. As above, a patient may be made to sit for a full impression of the patient's dentition to be made (the negative image of the patient's dentition). Subsequently, the full impression of the patient's dentition may be scanned to create a virtual model of the patient's dentition. This method, while reducing the time required modeling a patient's dentition, tends to be less accurate than using a positive die. Accordingly, the fit of the prosthetic may be less than ideal.

Finally, a patient's dentition may be modelled by intra-oral scanning. One example of this technique is provided in U.S. Pat. No. 8,454,365 to Boerjes et al. which is herein incorporated by reference in its entirety. Intra-oral scanning is a technique which utilizes an intra-oral scanner, which is capable of measuring a patient's dentition intra-orally. Accordingly, intra-oral scanning does not require the use of an impression, nor does intra-oral scanning require casting a die. However, as intra-oral scanners are still expensive, few dental practices carry the necessary equipment.

As the current techniques for creating virtual models of a patient's dentition suffer from undesirable attributes such as high production cost, waste of human resources, waste of materials, and low accuracy in reproducing a patient's dentition. Accordingly, a low cost, accurate virtual modelling technique which produces little material waste and requires as few human resources as possible is desirable.

### BRIEF SUMMARY OF THE TECHNOLOGY

Embodiments within the disclosure relate generally to modelling a patient's prepared tooth for assisting in preparing or fitting a prosthetic therefor. One aspect includes a method for scanning a negative impression of the patient's dentition, including at least the teeth surrounding and including the prepared tooth, to create a computer-generated negative virtual three-dimensional impression model which represents the negative impression of the patient's dentition; scanning a positive die created from a negative impression of the patient's dentition, which yields a computer-generated positive virtual three-dimensional die model representative of a limited part of the patient's dentition containing at least the prepared tooth; inverting the negative virtual three-dimensional impression model to create a positive virtual three-dimensional impression model; and merging the positive virtual three-dimensional impression model and the positive virtual three-dimensional die model to create a virtual three-dimensional dentition model.

According to one aspect of the disclosure the positive die may be created by pouring a material which can be cast into the negative impression and trimming the die down to a boundary outlining the prepared tooth and/or teeth adjacent the prepared tooth.

According to another aspect of the disclosure, the negative impression includes at least part of the patient's dentition opposing the prepared tooth.

According to one aspect of the disclosure the positive virtual three-dimensional impression model and the positive virtual three-dimensional die model may be aligned using n-point registration.

According to one aspect of the disclosure, aligning the positive virtual three-dimensional impression model and the positive virtual three-dimensional die model may include removing extraneous portions of the positive three-dimensional die model.

One embodiment includes a system for producing a virtual three-dimensional dentition model for modelling a patient's prepared tooth for assisting in preparing and fitting a prosthetic therefor. The system may include one or more computing devices, one or more scanning devices communicatively coupled to the computing device, and a memory storing instructions. The instructions executable by the one or more computing devices and/or scanning devices. The instructions may comprise scanning, by the one or more scanning devices, a negative impression of the patient's dentition, including at least the teeth surrounding and including the prepared tooth, to create optionally with said computing device a negative virtual three-dimensional impression model; scanning, by the one or more scanning devices, a positive die created from a negative impression of the patient's dentition, which is a positive representation of a limited part of the patient's dentition containing at least the prepared tooth, to create optionally with said computing device a positive virtual three-dimensional die model; inverting, by the one or more computing devices, the negative virtual three-dimensional impression model to create a positive virtual three-dimensional impression model; and merging, by the one or more computing devices, the positive virtual three-dimensional impression model and the positive virtual three-dimensional die model to create a virtual three-dimensional dentition model.

Another embodiment provides a non-transitory computer-readable medium. The non-transitory computer-readable medium may store instructions which are executable by one or more processors. When the instructions are executed by the one or more processors, the one or more processors may scan the negative impression of the patient's dentition, including at least the teeth surrounding and including the prepared tooth, to create a computer-generated negative virtual three-dimensional impression model; scan a positive die created from a negative impression of the patient's dentition, which yields a computer-generated positive virtual three-dimensional die model representative of a limited part of the patient's dentition containing at least the prepared tooth; invert the negative virtual three-dimensional impression model to create a positive virtual three-dimensional impression model; and merge the positive virtual three-dimensional impression model and the positive virtual three-dimensional die model to create a virtual three-dimensional dentition model.

### BRIEF DESCRIPTION OF THE DRAWINGS

FIG. 1 is a flow diagram in accordance with aspects of the disclosure.

FIG. 2 is an example of a negative impression and tray in accordance with aspects of the disclosure.

FIG. 3A is an example of a positive die being cast in a negative impression suitable for some embodiments of the present technology.

FIG. 3B is an example of a positive die casted from a negative impression suitable for some embodiments of the present technology.

FIGS. 4A and 4B are examples of the stages of trimming a positive die suitable for some embodiments of the present technology.

FIG. 5A is an example of a negative virtual three-dimensional impression model suitable for some embodiments of the present technology.

FIG. 5B is an example of a positive virtual three-dimensional impression model suitable for some embodiments of the present technology.

FIGS. 6A-6C are examples of a positive three-dimensional die model being trimmed in accordance with aspects of the disclosure.

FIGS. 7A-7C are examples of aligning a positive virtual three-dimensional die model with a positive virtual three-dimensional impression model suitable for some embodiments of the present technology.

FIGS. 8A and 8B are examples of merging a positive virtual three-dimensional die model with a positive virtual three-dimensional impression model suitable for an embodiment of the present technology.

FIG. 9 is an example virtual three-dimensional dentition model suitable for some embodiments of the present technology.

FIG. 10 is a graphical representation of an example system suitable for aspects of the disclosure.

### DETAILED DESCRIPTION

### Overview

The present technology relates to, by way of example, creating and providing a virtual three-dimensional (3D) dentition model of a patient's dentition with a prepared tooth, for preparing a prosthetic to fit onto the prepared tooth. For instance, according to the present method, a negative impression and a positive die may be scanned into computer-aided design (CAD) software. The CAD software may then create a virtual 3D dentition model representative of the patient's dentition.

The virtual 3D impression model may be created by scanning the negative impression formed from the patient's dentition. The negative impression may then be scanned into computer-aided design (CAD) software yielding a computer-generated negative virtual 3D impression model which is a virtual representation of the negative impression.

The negative virtual 3D impression model may be inverted within the CAD software, creating a positive virtual 3D impression model. The positive virtual 3D impression model may virtually represent a positive model of the negative impression and thereby a virtual representation of the patient's dentition.

A positive die, including the prepared tooth to be fitted for a prosthetic, may be negatively depicted in the negative impression. The positive die may be formed by filing a portion of the negative impression including the prepared tooth with a plaster type material. Once the plaster type material has set, the positive die has been cast. The positive die may then be scanned into the CAD software to yield a computer-generated positive virtual 3D die model which represents the positive die.

The positive virtual 3D die model may be aligned and compared with the positive virtual 3D impression model. The CAD program may be used to align the positive virtual 3D die model and the positive virtual 3D impression model. The CAD program may then register the positive virtual 3D die model to the positive virtual 3D impression model.

The positive virtual 3D die model may be merged with the positive virtual 3D impression model. The models may be merged by removing from the positive virtual 3D impression model, data which is already represented by the positive virtual 3D die model. The positive virtual 3D die, having already been aligned with the positive virtual 3D impression model, may then be stitched into the positive virtual 3D impression model.

A resulting virtual 3D dentition model is then created. The virtual 3D dentition model provides an accurate representation of the prepared tooth being fitted for a prosthetic. In addition the virtual 3D dentition model may provide an accurate representation of the surrounding and opposing dentition of the patient. The resulting virtual 3D dentition model may be utilized as a model for assisting in the creation of a custom prosthetic for the patient.

### Example Systems

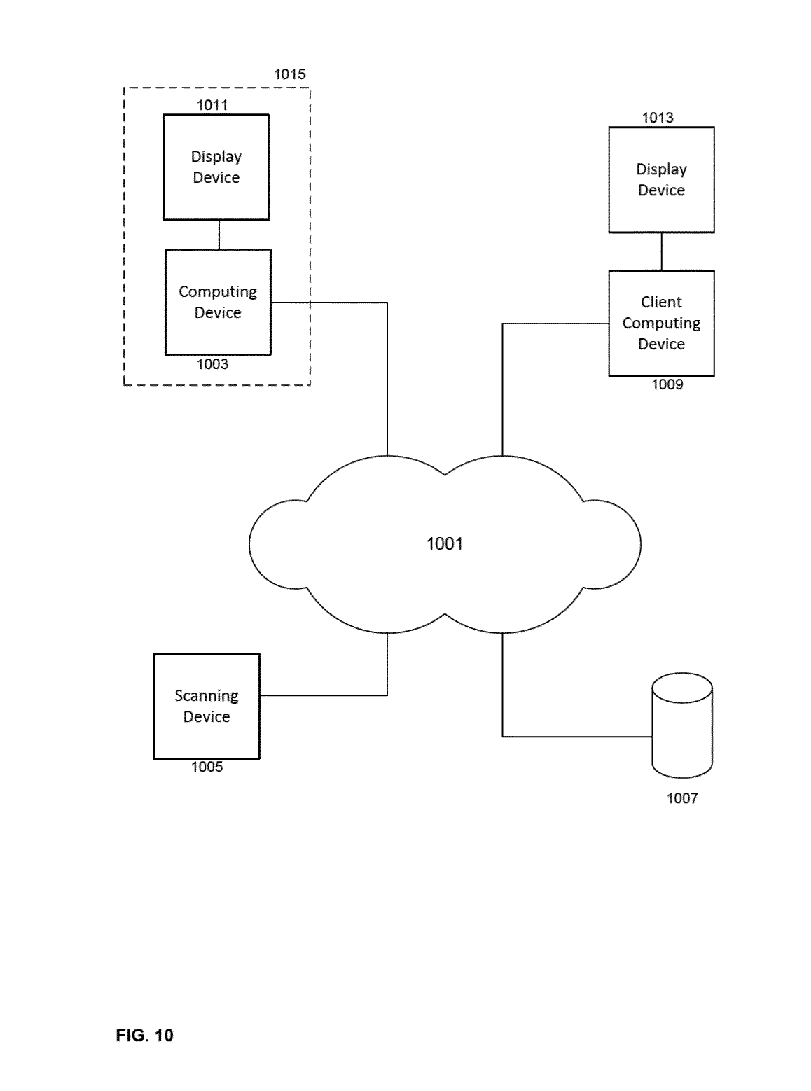

Turning to FIG. 10, a diagram of a virtual modelling system which may be used to create and output models of patient dentitions is shown. The system may include various computing, scanning, storing, and display devices. The computing, scanning, storing, and display devices can be used alone and/or in a networked configuration in accordance with various aspects of the present invention. For example, FIG. 10 illustrates a virtual modelling system having a plurality of computing devices 1003 and 1009, as well as displays 1011 and 1013, scanning devices 1005 and storage devices 1037.

The devices within the virtual modelling system may be interconnected via a local and/or remote network 1001. Such connections may be via a wired or wireless communications network such as a Wi-Fi network, local area network (“LAN”), a wide area network (“WAN”), cellular networks, the Internet, etc. In some embodiments, the devices within the virtual modelling system may be interconnected via a direct connection. For example, scanning device 1005 may be connected directly to computing device 1003.

The devices within the virtual modelling system may also be integrated into a common housing. For example, computing device 1003, display device 1011, and storage device 1007 may be integrated into a single case.

Each computing device, 1003 and 1009, may include one or more processors communicably coupled to memory. Additionally, the computing devices may be a laptop computer, a desktop computer, a netbook, a server, a smartphone, a tablet computer, a cellular telephone, or any other device containing programmable hardware and/or software for executing instructions. For example, as shown in FIG. 10, computing devices 1003 and 1009 may be desktop computers.

Each computing device may include one or more user inputs such as a keyboard, mouse, and/or various other types of input devices such as a touch screen etc. Further, the computing devices may include one or more displays, including, but not limited to, a plasma screen, LCD screen, OLED, TV, projector, etc. For example, display device 1011 may be an LCD screen and display device 1013 may be an OLED screen.

Each computing device may include software including one or more programs for modelling a patient's dentition. Program's for modelling a patient's dentition may include, for example, possible software may include 3Shape's CAD programs by 3shape, and/or Exocad by Exocad GmbH, dental computer-aided design (CAD) programs, and/or any other digital scanner software that can turn acquired data into point clouds including volumetric or polygonal data. As shown in FIG. 10, the display device 1011 and computing device 1003 may collectively be a CAD system 1015.

Additionally, the computing devices may also run software which can manipulate the 3D data. For example, computing device 1003 may run Geomagic Wrap® or any software that can manipulate 3D Data as described below.

As shown in FIG. 10, the scanning device 1005 may be anything that can create 3D data based on information received from scanning an object. For example, the scanning device 1005 may be a white light scanner such as “Identica” produced by Medit, a blue light scanner such as “Identica Blue” by Medit, a laser scanner, an optical scanner, a CT or X-Ray scanner, a Touch Probe, and/or a stereoscopic scanner. Additional scanners may also be used.

The storage device 1007 may be comprised of any type of storage capable of storing information accessible by the computing devices. For example, storage device 1007 may be a magnetic hard disk, a solid state hard disk, flash memory, magnetic tape, floppy disk, optical disk, RAM ROM, and/or any other type of storage.

### Example Methods

In order to manufacture a prosthetic that will properly fit within a patient's dentition, the tooth on which the prosthetic is to be placed needs to be prepared. To prepare a tooth for receiving a prosthetic the tooth may need to have all damage and infections removed. Additionally, the tooth may need to be shaped to a form which will enable it to receive the prosthetic. A tooth which has been shaped to receive a dental prosthetic may be known as a prepared tooth. For example, in order to receive a dental crown, a damaged tooth may be ground down to eliminate a crack, weak area, infection, decay, etc. Additionally, the tooth may be formed into a shape which can receive a dental prosthesis. The portion of the tooth which remains is the prepared tooth. A dental crown may then be secured over the prepared tooth.

While only a single tooth is described as being prepared, this reference equally applies to multiple teeth which are being prepared for subsequent restoration or fitting for prosthetics. Accordingly, all examples directed to a single tooth, may be performed on more than one tooth as well.

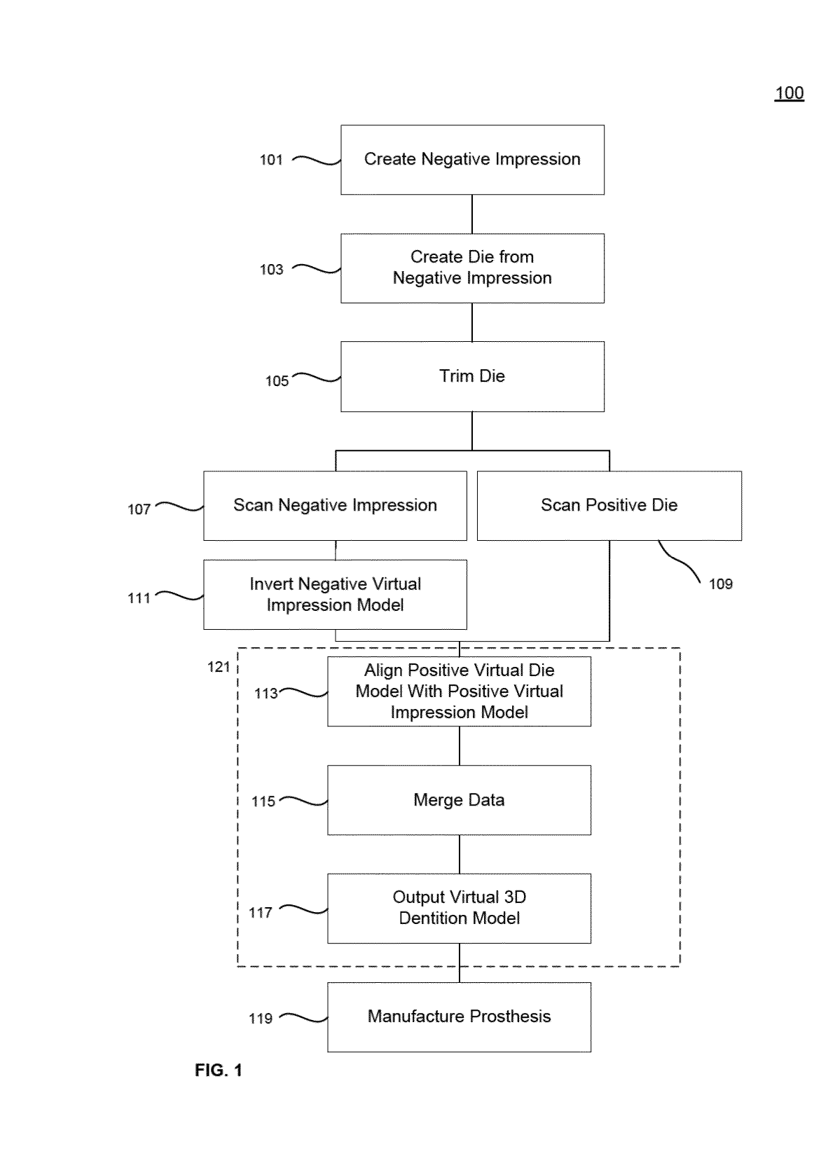

Turning to FIG. 1, a flowchart of creating a virtual 3D dentition model representing a patient's dentition according to an embodiment of the present invention is shown. While the steps appear in a certain order, it will be appreciated by one skilled in the art that the orders of steps may be changed.

As shown in step 101, a negative impression of a patient's dentition, including the prepared tooth (or teeth) may be created. In that regard, a negative impression of the prepared tooth as well surrounding dentition may be created. While a negative impression of the entire dentition of the patient may be taken, only a small portion of the dentition, including and immediately adjacent to the prepared tooth is necessary. In addition, all or a portion of the dentition opposing the prepared tooth may be included in the negative impression.

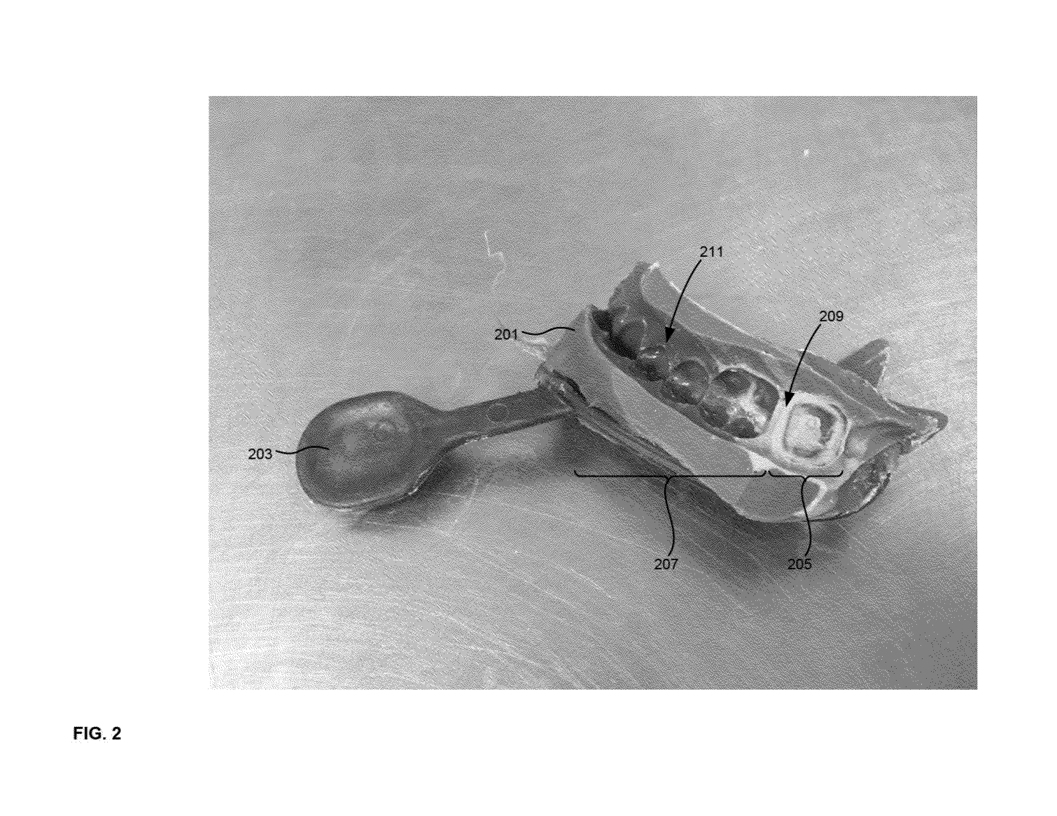

Turning to FIG. 2, a negative impression 201 formed on a triple tray 203 is shown. The tray may be of any type used in modelling a patient's dentition. For example, the tray may be a single tray which captures only one side of a patient's dentition (upper or lower set of teeth), a triple tray which captures both sides of a patient's mouth at the same time (upper and lower set of teeth). Additionally, the tray may be a single tray plus bite which, like the single tray, captures only a single side of a patient's mouth using a tray, but also captures an additional impression representing the patient's bite on wax, PVS, or other material without the use of a tray. The single tray plus bite may also include an opposing stone. The opposing stone may be created from an impression of the patient's opposing dentition. Further, any other type of tray which can capture negative of the patient's dentition may also be used.

Depending on the type of tray which is used, as well as the size of the tray, the negative impression will include more or less of a patient's dentition. For example, in FIG. 2, a triple tray 203 is shown, and the negative impression 201 includes the area of the prepared tooth 205 and the surrounding dentition 207. Additionally, on the underside of the tray 203, the negative impression 201 includes the opposing dentition as well (not shown).

The negative impression may be formed from a single material or a combination of materials. Accordingly, the negative impression may be made from combinations of polyvinyl siloxane (PVS) materials of varying viscosity (e.g. heavy, medium, or light), or other types of material suitable for forming a negative impression, such as silicon, vinyl polysiloxane (VPS), alginate, and hydrocolloid. For example, negative impression 201 is made with heavy body PVS 209 in the area of the prepared tooth 205 and light body PVS 211 elsewhere, including the surrounding dentition 207.

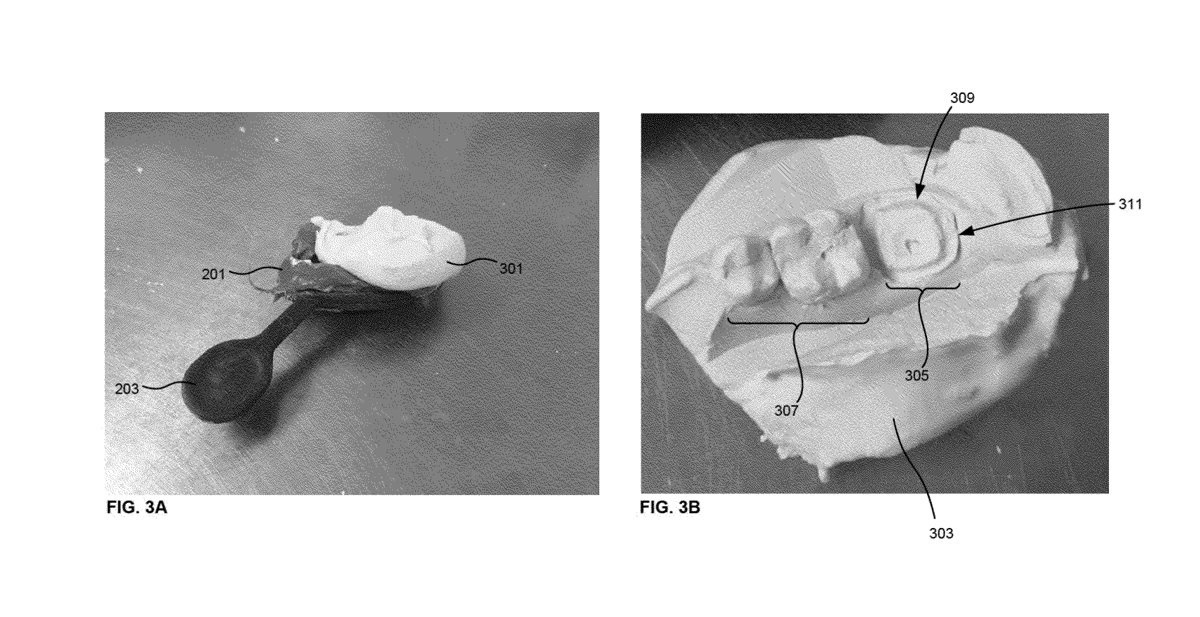

Step 103, of FIG. 1, shows a positive die representative of the prepared tooth may be formed from the negative impression. In this regard, and as shown at 301 in FIG. 3A, the portion of the negative impression 201 including the prepared tooth may be filled with a material which can be cast, such as stone, plaster, epoxy, or any other suitable material for casting a positive die. Once the material has set, the positive die 303 may be removed from the negative impression 201.

The positive die may represent a positive model of the prepared tooth as well as the surrounding teeth. For example, as shown in FIG. 3B, the positive die 303 may include a representation of the prepared tooth 305 and the surrounding teeth 307. Additionally, the positive die 303 may include an indentation 309. The indentation 309 may indicate the portion of the positive die which includes the representation of the prepared tooth 305. Further, the positive die 303 may include a margin line 311, which represents the outer portion of the positive die on which the prosthetic may cover and/or attach. Further, a clearly defined margin line 311 may be required for accurate modelling of a patient's dentition.

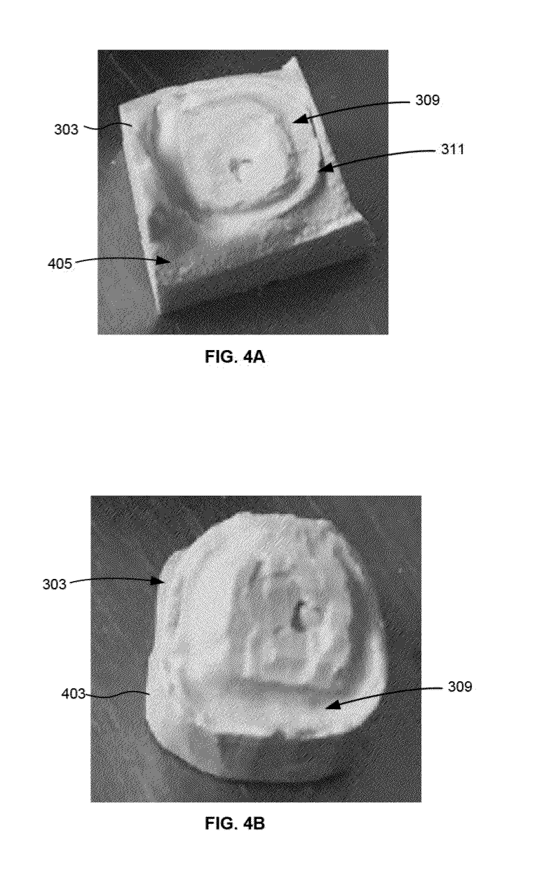

As shown in step 105 of FIG. 1, the positive die may be trimmed so only a portion of the positive die containing the prepared tooth and/or some neighboring teeth remain. In this regard, a positive die may only need to be trimmed and/or ground when a margin line is not clearly developed around the prepared tooth. For example, trimming or grinding can be performed to remove portions of the positive die up until the margin line. A grinding wheel or other rough grinding apparatus may be used to remove the undesired teeth and other extraneous portions of the positive die. In the examples shown in FIGS. 4A and 4B, the positive die 303, does not have a clearly defined margin line 311 all the way around the prepared tooth 305. Accordingly, the positive die may be ground or trimmed to near the boundaries of the indentation 309. Though, in some examples, the positive die may be ground and trimmed to an area before or after the indentation 309. In this regard, the positive die 303 may be ground and/or trimmed towards the indentation 309. Accordingly, the positive die 303 may have a sizable area of material outside of the indention 405.

As the die 303 is ground closer to the prepared tooth, outlined by the indentation 309, a finer grinding method may be used. In some instances a hand operated grinding apparatus or other suitable device for grinding a positive die may be used. For example, FIG. 4B shows the positive die 303 being ground down by finely textured material. Accordingly, the positive die 303 may have a minimal area of material outside of the indention 403. The positive die 303 may then be ground until only the portion of the die 303 within the indentation 309 remains. Upon completion of grinding and/or trimming, a fully trimmed positive die representative of the patient's prepared tooth remains.

As shown in FIG. 1, the negative impression may be scanned into a CAD system. As described above, any type of scanning device which can create 3D data based on information received from scanning an object may be used. In this regard, the negative impression may be placed into a clamping device or any other scanning holder and the scanning device may create the 3D data based on information received from scanning the negative impression 201.

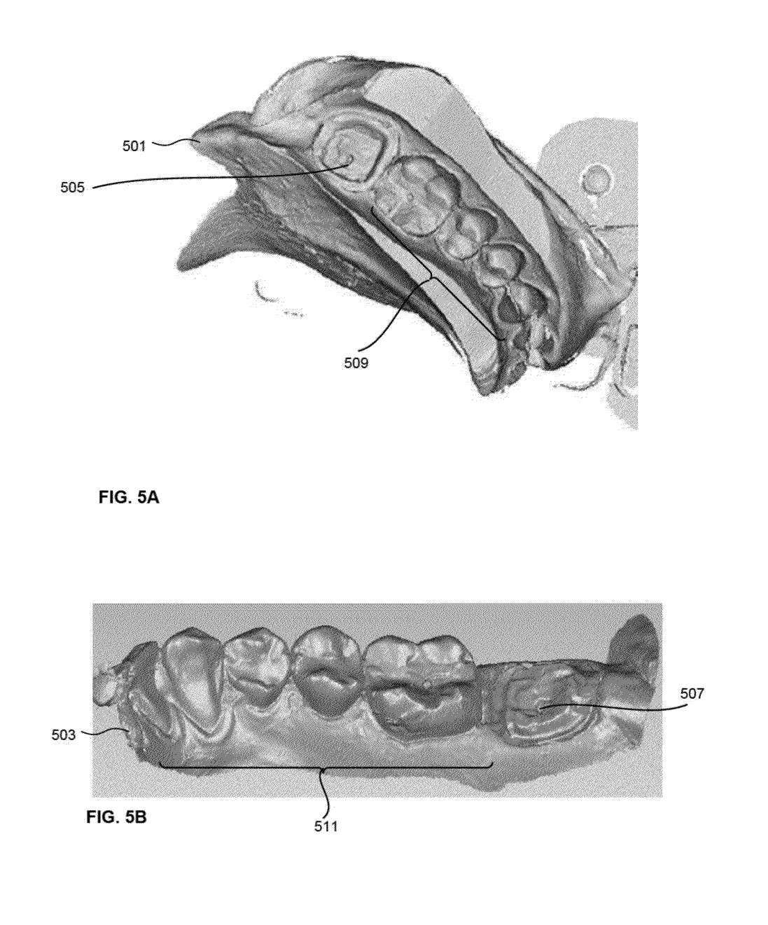

As shown in FIG. 5A, the scanning device may select areas for high detail scanning on the impression 201. In this regard, the scanning device 1005 may determine areas of interest on the negative impression 201 where accurate results are useful to creating an accurate model of a patient's dentition. The negative impression 201 may then be scanned into the CAD system. While the current example only discusses a single negative impression being scanned, in some embodiments multiple negative impressions can be scanned at once.

The resulting data output from the scanning device and input into the CAD program may be a negative virtual three-dimensional impression model representative of the negative impression. For example, as shown in FIG. 5A, a negative three-dimensional (3D) impression model 501 is displayed by the CAD system. The negative virtual 3D impression model 501 may include a negative representation of the prepared tooth 505. Additionally, the negative virtual 3D impression model may include a negative representation of the surrounding dentition 509. Further, though not shown, the negative virtual 3D impression model may also include part or all of the patient's dentition opposing the prepared tooth.

The CAD system may then convert the negative virtual 3D impression model into a positive virtual 3D impression model, as shown in step 111. Turning to FIG. 5B, the negative virtual 3D impression model 501 is inverted to create a positive virtual 3D impression model 503 representative of the negative impression 201 being inverted, and thereby representative of the patient's dentition. The positive virtual 3D impression model 503 includes a positive representation of the prepared tooth 507 as well as a positive representation of the surrounding dentition 511.

While FIG. 1 shows the positive die being created 103 prior to the negative impression being scanned 107, the order may be reversed. Accordingly, the negative impression may be scanned prior to the die being poured.

As show in step 109 of FIG. 1 the positive trimmed die may be scanned into the CAD system. The scanning device may be the same as used for the scanning the negative impression 201, or any other acceptable scanning device. In this regard, the positive trimmed die may be placed into blue tack or any other scanning holder and the scanning device may create the 3D data based on information received from scanning the positive trimmed die. While the current example only discusses a single positive trimmed die being scanned, in some embodiments multiple trimmed dies can be scanned at once.

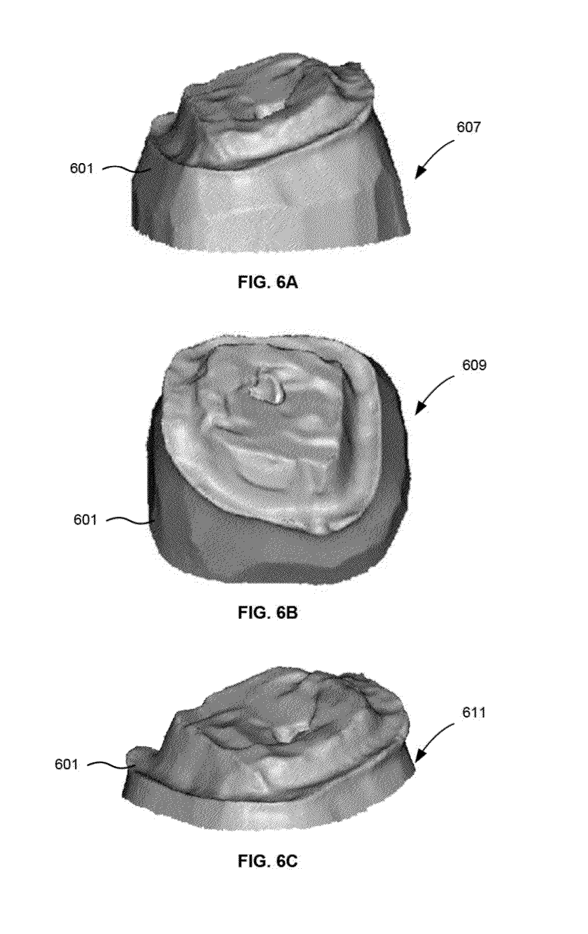

The resulting data output from the scanning device and input into the CAD program, during and after scanning the positive trimmed die, may be a representation of the positive trimmed die. For example, as shown in FIG. 6A, a positive virtual three-dimensional (3D) die model 601 is displayed by the CAD system.

Extraneous portions of the positive virtual three-dimensional die model may be removed. Extraneous portions of the positive virtual 3D die model may be removed to avoid reproducing unnecessary portions of the patient's dentition in final virtual and/or tangible 3D dentition models. For example, as shown in FIG. 6A, the positive virtual 3D die model may include a lower boundary 607. The lower boundary 607 of the positive 3D die model 601 may contain more data than is necessary to create an accurate model of a patient's dentition. Accordingly, as shown 609 and 611 of FIGS. 6B and 6C, respectively, portions of the lower boundary 607 may be removed in increments. In some embodiments the lower boundary 607 may be adjusted in a single step, or remain completely unaltered.

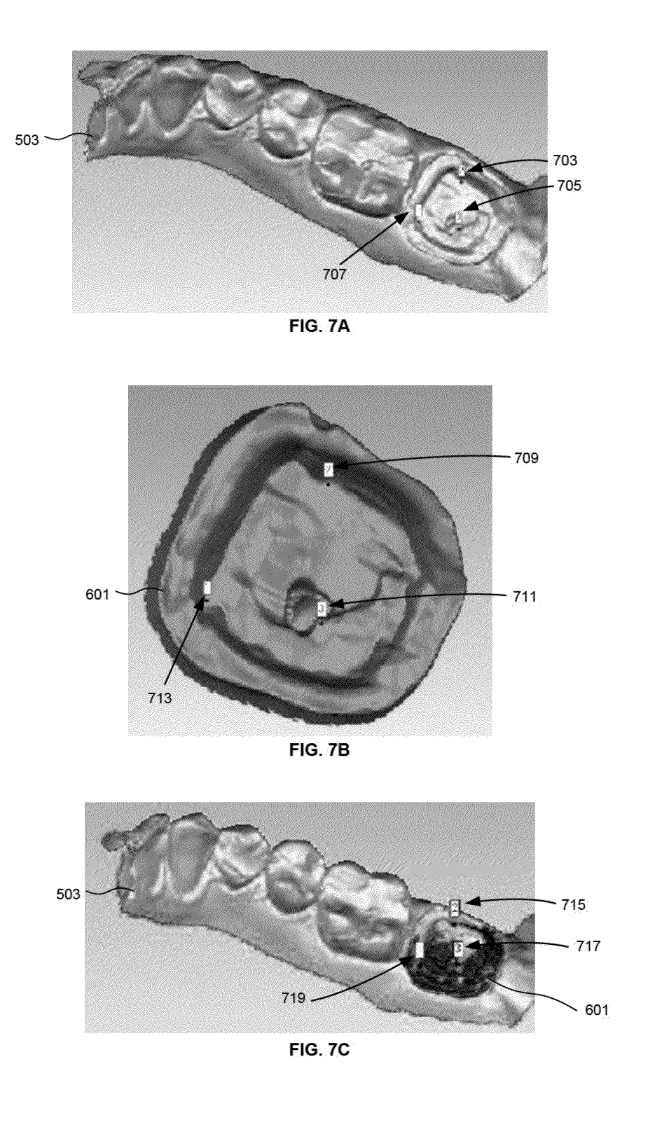

As shown in FIGS. 7A and 7B, the CAD model may contain both the positive virtual 3D die model 601 and the positive virtual 3D impression model 503. The CAD program may be utilized to merge together the positive virtual 3D impression model 503 with the positive virtual 3D die 601 to accurately recreate the prepared tooth. Positive die models may sometimes be more accurate than impression models, and accordingly, the portion of the positive virtual 3D impression model 503 representing the prepared tooth may be replaced by the positive virtual 3D die model 601 as shown in FIG. 1, section 121.

As shown in FIG. 1, step 113, the positive virtual 3D impression model 503 representing the prepared tooth is aligned with the positive virtual 3D die model 601. Turning to FIG. 7C, the portion of the positive virtual 3D impression model 503 representing the prepared tooth is aligned with the positive virtual 3D die model 601 through N-point registration. The CAD system may receive input marking registration points which represent common areas between the positive virtual 3D die model 601 and the positive virtual 3D impression model 503. While any number of common points, such as one point may be determined, three points usually provides a satisfactory result. Based on the registration points, the CAD program may then align the positive virtual 3D die model 601 with the positive virtual 3D impression model 503. As shown in FIGS. 7A and 7B, points 703, 705, and 707 on the positive virtual 3D impression model 503 align with points 709, 711, and 713 on the positive virtual 3D die model 601. As is shown in FIG. 7C, the positive virtual 3D impression model 503 is aligned with the positive virtual 3D die model at points 715, 717, and 719.

The alignment of the positive virtual 3D die model and positive virtual 3D impression model may be further corrected by the CAD program. In this regard the CAD program may do a global registration on the two objects to further refine the alignment. A global registration may enable the CAD program to review the surfaces on the positive virtual 3D die model 601 and the surfaces of the positive virtual 3D impression model 503 to determine matching features. Accordingly, the two models may be positioned so that these matching features are aligned. By doing so the computer may provide a more accurate alignment than just performing manual n-point registration alignment.

In some embodiments, manual point registration may be bypassed. In this regard, the CAD program may align corresponding surfaces of the positive virtual 3D die model 601 with surfaces of the positive virtual 3D impression model 503 automatically.

As shown in step 115 of FIG. 1, upon aligning the positive virtual 3D die model 601 with the positive virtual 3D impression model 503, the models may be merged together. In this regard, the portion of the positive virtual 3D impression model 503 which represents the prepared tooth may be removed, leaving only the positive virtual 3D die model to represent the prepared tooth.

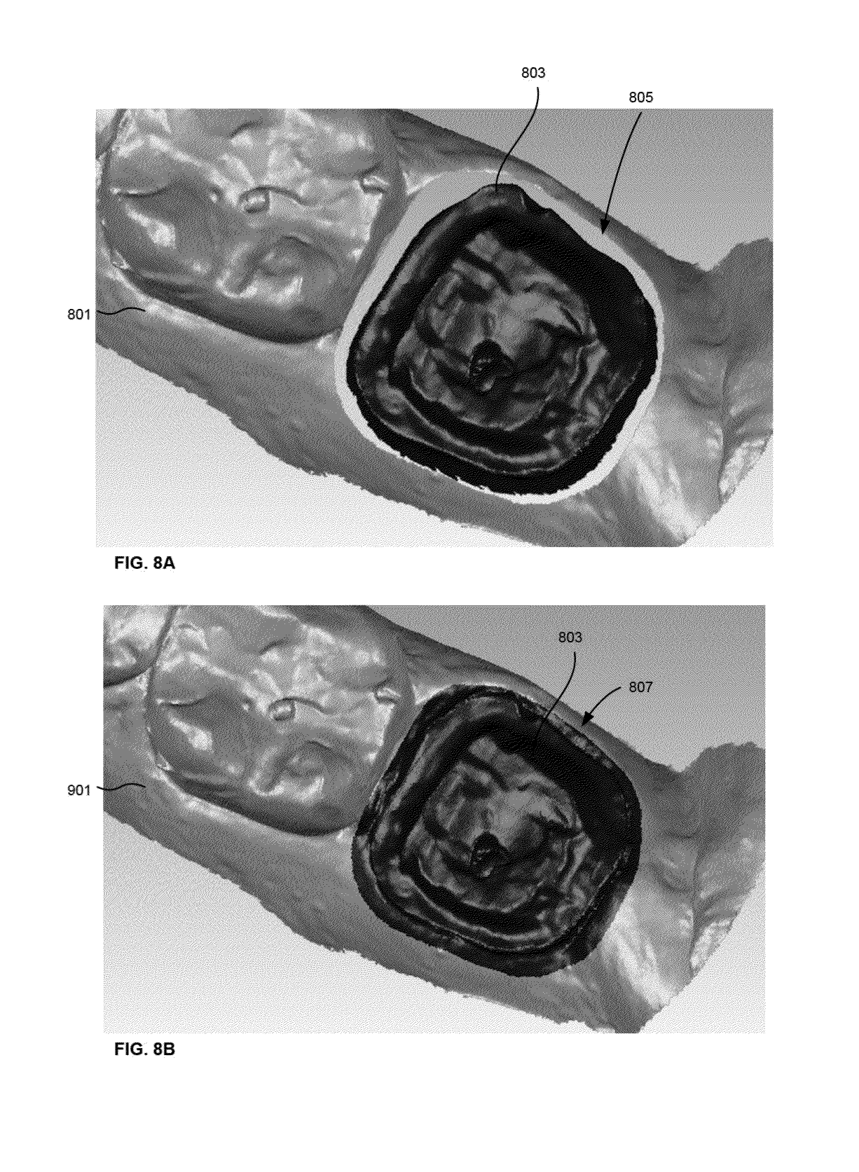

Turning to FIGS. 8A and 8B, the display of the CAD system is shown, including the positive 3D die model 601 aligned with the positive virtual 3D impression model 503. Portions of the positive 3D die model may be below portions of the positive virtual 3D impression model, and accordingly, are not visible. The CAD system may select the portions of the models which overlap. For example, the CAD system may select the visible portions of the positive virtual 3D die model 601 and the visible portion of the positive virtual 3D impression model 503, representing the prepared tooth 803. The selected portions of the positive virtual 3D die model may then be deselected, leaving only a selection of a portion of the positive virtual 3D impression model 503 remaining. The selected portion of the positive virtual 3D impression model 503 may then be slightly expanded and then deleted.

As a result of the expanding of the selected portion of the positive virtual 3D impression model 503, a hole will remain between the positive virtual 3D die model 601 and the positive virtual 3D impression model 503. The hole is shown in FIG. 8A at 805. In that regard, the hole 805 which remains must be filled by bridging the positive virtual 3D die model 601 and the positive virtual 3D impression model 503. As the positive virtual 3D die model 601 is already properly aligned with the positive virtual 3D impression model 503, the positioning between the two models is already correct. For example, the outer portions of the positive virtual 3D die model may be connected to areas of the positive virtual 3D impression at a select number of points. In this regard, about four points may be connected, though fewer or more are possible. The CAD program may then connect the positive virtual 3D impression model to the positive virtual 3D die model by filling the hole as shown at 807 in FIG. 8B.

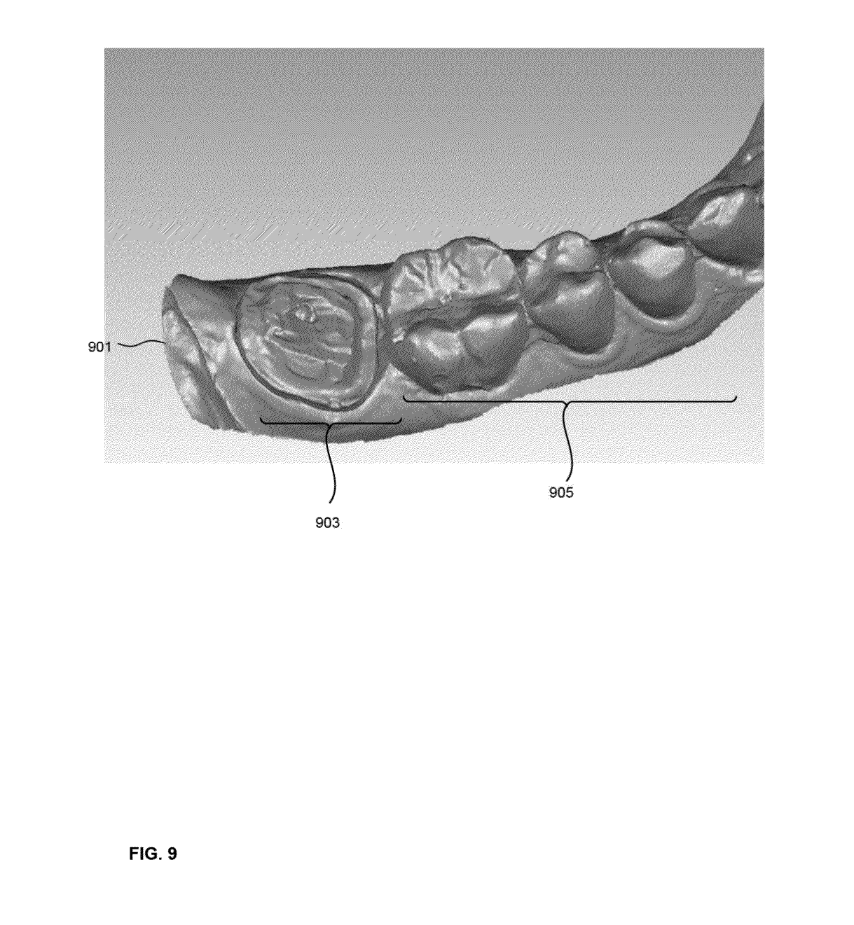

The result of the bridging is a completed virtual 3D dentition model of the patient 901, as shown in FIG. 9. In some embodiments hole-filling may be used in place of bridging.

In other embodiments different methods of merging the positive virtual 3D impression model 503 and positive virtual 3D die model 601 are possible. For instance, during and/or after registration of the positive virtual 3D impression model and positive virtual 3D die model, points of discrepancies may be determined between the positive virtual 3D impression model and positive virtual 3D die model. It may then be determined if the discrepancies are at critical points of the model which would affect modelling of the prepared tooth. Such a discrepancy may also affect the prosthetic which may be created from the model. The more accurate portions of the positive virtual 3D impression model and positive virtual 3D die model may be selected. The selected portions may then be used when merging the positive virtual 3D impression model and positive virtual 3D die model. Accordingly, the less accurate portions of the positive virtual 3D impression model 503 and/or positive virtual 3D die model representing the prepared tooth, may be removed from the CAD program leaving only the most accurate portions to represent the prepared tooth. Finally, other methods of merging the positive virtual 3D impression model 503 and positive virtual 3D die model 601 are possible such as averaging points at varying positions on the positive virtual 3D impression model and positive virtual 3D die model representing the prepared tooth. The averaged values may then be used to represent the prepared tooth.

The CAD program may be capable of automatically aligning and merging the positive virtual 3D die model 601 with the positive virtual 3D impression model 503. In this regard, the CAD program can be coded to automatically perform most, if not all of the steps required to align and merge the models. In some instances input may be needed to remove unnecessary portions of the positive 3D die model and also for n-point registration, as explained above. For example, the pseudo-code provided in table 1 may be used after receiving the input previously described. The resulting data from performing the steps of table 1 is the virtual 3D dentition model 901.

TABLE 1
1. Extrude bottom boundary of the positive virtual 3D die model 30 mm,
or until the boundary is no longer in contact with the positive virtual 3D
impression model;
2. Extrude bottom boundary of positive virtual 3D die model 30 mm or
until the boundary it no longer touches the positive virtual 3D impression
model;
3. Shell Die .2 mm two both directions;
4. Boolean Shelled Die and positive virtual 3D impression model to create
a hole;
5. Shell die .3 mm in positive direction from the normal side of the object
only;
6. Boolean Positive Shelled Die and positive 3D impression model to
subtract shelled die from positive 3D impression model, but retain the
interior of the shell;

As shown in Table 1, the CAD system may extrude the bottom of the positive virtual 3D die model 601 by 30 mm, or until the bottom boundary of the positive virtual 3D die model is no longer in contact with any portion of the positive virtual 3D impression model 503. After extrusion of the positive virtual 3D die model 601, the CAD system may expand the outer boundary surface, also known as the shell, of the positive virtual 3D die model by 0.2 mm, or more or less. The expanded, or shelled, die may then be removed, along with any area of the positive virtual 3D impression 503 which is in contact with the shelled die. Accordingly a hole will be left in the positive virtual 3D impression model 503 in which the original positive virtual 3D die model 601 will remain. As discussed above, other methods of merging the positive virtual 3D impression model 503 and the positive virtual 3D die model 601 are possible.

The positive virtual 3D die model may again be shelled in the positive direction only by 0.3 mm, or more or less. The shelled die and the portion of the positive 3D impression overlapped with the shelled die will go through a Boolean operation subtracting one object from the other. Accordingly, only the original positive virtual 3D die model, along with the positive virtual 3D impression model which remains will be displayed.

As shown in step 117 of FIG. 1, the resulting virtual 3D dentition model may be output. For example, as shown in FIG. 9, the resulting virtual 3D dentition model provides an accurate representation of the patient's dentition in the area of the prepared tooth 903. Additionally, the virtual 3D dentition model provides an accurate representation of the dentition surrounding the prepared tooth 905. Though not shown, the virtual 3D dentition model may also include a model of the patient's opposing dentition as well as all of the patient's surrounding dentition.

Turning to step 119 of FIG. 1, a prosthetic may be created based on the virtual 3D dentition model 901. In this regard, a prosthetic may be designed virtually in a CAD program. Alternatively, the virtual 3D dentition model may be manufactured into a tangible product. As the virtual dentition model provides an accurate representation of the patient's prepared tooth and other dentition, the resulting prosthetic may be assured a secure and accurate fit.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A method for modelling a patient's prepared tooth for assisting in preparing or fitting a prosthetic therefor, comprising:
scanning a negative impression of the patient's dentition, including at least the teeth surrounding and including the prepared tooth, to create a computer-generated negative virtual three-dimensional impression model which represents the negative impression of the patient's dentition;
scanning a positive die created from a negative impression of the patient's dentition, which yields a computer-generated positive virtual three-dimensional die model representative of a limited part of the patient's dentition containing at least the prepared tooth;
inverting the negative virtual three-dimensional impression model to create a positive virtual three-dimensional impression model; and
merging the positive virtual three-dimensional impression model and the positive virtual three-dimensional die model to create a virtual three-dimensional dentition model.

2. The method of claim 1, wherein the prepared tooth includes one or more teeth.

3. The method of claim 1, wherein the positive die is created by:
pouring a material which can be cast into the negative impression;
trimming the die down to a boundary outlining the prepared tooth and/or teeth adjacent the prepared tooth.

4. The method of claim 1, wherein the negative impression includes at least part of the patient's dentition opposing the prepared tooth.

5. The method of claim 1 further including, aligning the positive virtual three-dimensional impression model and the positive virtual three-dimensional die model.

6. The method of claim 5 wherein aligning the positive virtual three-dimensional impression model and the positive virtual three-dimensional die model includes performing n-point registration.

7. The method of claim 5, wherein aligning the positive virtual three-dimensional impression model and the positive virtual three-dimensional die model includes removing extraneous portions of the positive three-dimensional die model.

8. The method of claim 1, wherein the merging includes removing a portion of the positive virtual 3D impression model which represents the prepared tooth.

9. The method of claim 8, wherein the merging further includes expanding the portion of the positive virtual 3D impression model representing the prepared tooth prior to removing the portion.

10. The method of claim 8, wherein the merging further includes bridging the positive virtual three-dimensional impression model and the positive virtual three-dimensional die model.

11. A system for producing a virtual three-dimensional dentition model for modelling a patient's prepared tooth for assisting in preparing and fitting a prosthetic therefor, comprising:
one or more computing devices;
one or more scanning devices communicatively coupled to the computing device; and
a memory storing instructions, the instructions executable by the one or more computing devices and/or scanning devices;
wherein the instructions comprise:
scanning, by the one or more scanning devices, a negative impression of the patient's dentition, including at least the teeth surrounding and including the prepared tooth, to create optionally with said computing device a negative virtual three-dimensional impression model;
scanning, by the one or more scanning devices, a positive die created from a negative impression of the patient's dentition, which is a positive representation of a limited part of the patient's dentition containing at least the prepared tooth, to create optionally with said computing device a positive virtual three-dimensional die model;
inverting, by the one or more computing devices, the negative virtual three-dimensional impression model to create a positive virtual three-dimensional impression model; and
merging, by the one or more computing devices, the positive virtual three-dimensional impression model and the positive virtual three-dimensional die model to create a virtual three-dimensional dentition model.

12. The method of claim 11, wherein the positive die is created by:
pouring a material which can be cast into the negative impression;
trimming the die down to a boundary outlining the prepared tooth and/or teeth adjacent the prepared tooth.

13. The system of claim 11, wherein the negative impression includes at least part of the patient's dentition opposing the prepared tooth.

14. The system of claim 11 wherein the one or more computing devices aligns the positive virtual three-dimensional impression model and the positive virtual three-dimensional die model.

15. The system of claim 14 wherein the one or more computing devices align the positive virtual three-dimensional impression model and the positive virtual three-dimensional die model by performing n-point registration.

16. The system of claim 14, wherein the one or more computing devices aligning the positive virtual three-dimensional impression model and the positive virtual three-dimensional die model includes removing extraneous portions of the positive three-dimensional die model.

17. The system of claim 11, wherein the one or more computing devices merging includes removing a portion of the positive virtual 3D impression model which represents the prepared tooth.

18. The system of claim 17, wherein the one or more computing devices merging further includes expanding the portion of the positive virtual 3D impression model representing the prepared tooth prior to removing the portion.

19. A non-transitory computer-readable medium storing instructions, which when executed cause one or more processors to:
scan a negative impression of the patient's dentition, including at least the teeth surrounding and including the prepared tooth, to create a computer-generated negative virtual three-dimensional impression model;
scan a positive die created from a negative impression of the patient's dentition, which yields a computer-generated positive virtual three-dimensional die model representative of a limited part of the patient's dentition containing at least the prepared tooth;
invert the negative virtual three-dimensional impression model to create a positive virtual three-dimensional impression model; and
merge the positive virtual three-dimensional impression model and the positive virtual three-dimensional die model to create a virtual three-dimensional dentition model.

20. The non-transitory computer-readable medium of claim 19, storing further instructions that when executed cause the one or more processors to align the positive virtual three-dimensional impression model and the positive virtual three-dimensional die model by performing n-point registration.
